(19) United States
(12) Patent Application Publication
(10) Pub. No.: US 2008/0225657 A1
(43) Pub. Date: Sep. 18, 2008

(54) Optical Disc Actuator Control at Optimal Bandwidth

(75) Inventors: Jacques Schreurs, Roggel (NL); Antonius Leonardus Johannes Dekker, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/813,104

(22) PCT Filed: Jan. 5, 2006
(86) PCT No.: PCT/IB2006/050043

§ 371 Date: Jun. 29, 2007

Related U.S. Application Data
(60) Provisional application No. 60/642,683, filed on Jan. 10, 2005.

(51) Int. Cl. G11B 7/00

(52) U.S. Cl. 369/44.35

(57) ABSTRACT

A method and apparatus for a feedback loop (30) used with a servo controller (14) to control an actuator (13, 17) of an optical disc drive. The gain (18) in the feedback loop (30) determines the bandwidth of the actuator (13, 17) in accordance with predetermined parameters for predetermined intervals. High rotational disk speeds, especially during writing, necessitate that the actuator servo controller feedback loop have a high loop gain and can become critical. Higher gains will cause oscillations in the loop. Loop gain spread from sources such as detector sensitivity differences on recorded and non recorded areas, is controlled by setting the control gain at an initial value lower than the maximal value in order to avoid oscillations. The control gain is then adjusted to a maximum value by means of an AGC mechanism. This AGC mechanism is activated for short periods of times to adjust the gain.

The present invention relates to servo controllers used in optical discs and, more particularly, to feedback loop controls used to maintain Automatic Gain Control for actuators of an optical disc drive.

In optical reading and recording devices, a light spot emitted from a laser is placed upon an optical disc to facilitate the exchange of data. An objective lens is used to focus data on the optical disc. The objective lens requires movement in a focus direction to maintain proper focus on the disc. Numerous factors can create problems, including but not limited to: Laser Shot Noise; dead detector zones; optical misalignment; optical skew; thickness variation; disc tilt; disk misalignment; and disc warping.

Additional factors can relate to the amount of laser power that is employed in any given system. During writing cycles, the laser power that is employed is substantially higher than the laser power employed during reading cycles. Accordingly, the amount of power reflected from the optical media can vary greatly upon depending on whether a read or a write operation is being performed. Additionally, variations exist in the light reflected from the optical media that is a function of the laser being positioned on either a written area or an unwritten area. These positional fluctuations occur as the laser move over areas that have already been written compared to unwritten areas that have different reflectivity levels.

An actuator controls the focusing lens in optical disc drives. The actuator has a control loop that controls the steering that is applied to the actuator in accordance with rotational disc speeds. The control loop gain is dependent on numerous factors such as temperature, the disc area being focused; and whether the optical disc drive is currently reading or writing to an optical disc.

Prior art techniques have been applied to control loop gain. One such gain control techniques is an automatic gain control that injects a periodic signal having a fundamental frequency around the zero dB cross over frequency of the servo loop. The measured response to this injected signal can be used to control the loop gain. A problem that exists with this technique is that the gain control is not constantly active during the reading and writing of discs. Typically the periodic signal is injected initially and repeated later in time if necessary.

Prior art techniques apply Automatic Gain Control to the control loop gain during predetermined periods. A problem that exists with these prior art methods is that they are not always active and accordingly do not fully optimize the bandwidth of the disc actuator.

These prior art techniques do not effectively control loop gain in modern applications the employ high speed, high density discs, such as a DVD, CD or BD (Blu-ray Disc). Current optical disc drives have rotational frequencies on the order of about 10,000 rpm. Such high rotational frequencies require very high bandwidths for actuator servos that control tracking and focusing of the optical pick-up.

From the foregoing discussion, it should be apparent that there remains a need within the art for a method and apparatus that can effectively optimize the control loop gain in modern applications.

This invention addresses the shortcomings within the prior art by providing servo controllers with a feedback loops that control the focus and radial actuator of an optical disc drive. The loop gain in this loop determines the bandwidth of the control and is set in accordance with at least one predetermined parameter. At high speeds (48× for CD, 16× for DVD, 4× for BD), especially during writing, the actuator servo controller feedback loop requires a high loop gain to be effective. This need can become critical. Higher gains will cause oscillations in the loop.

Loop gain spread can be caused by numerous sources, for example detector sensitivity differences on recorded and non recorded areas. It is an object of the invention to insure that the control gain is set at a value that is typically lower than the maximal value in order to avoid oscillations. This object is satisfied by the inventive control gain that is repetitively adjusted to a maximum value by an AGC mechanism. This AGC mechanism is activated for a short time to adjust the gain. The signal that is injected by this circuit is sufficiently low to avoid high radial or axial excursions that influence the writing quality.

The invention corrects for variations that occur in reflected laser signals used in recordable optical discs by applying automated gain control at regular intervals.

These and objects of the invention are provided by compensating applying a focused beam on to an optical disc, detecting light reflected from the focused beam applied to the optical disc, determining if at least one of a plurality of parameters is satisfied, and applying automated gain control to a signal derived from detected light reflected from the focused beam if the at least one of the plurality of parameters is satisfied.

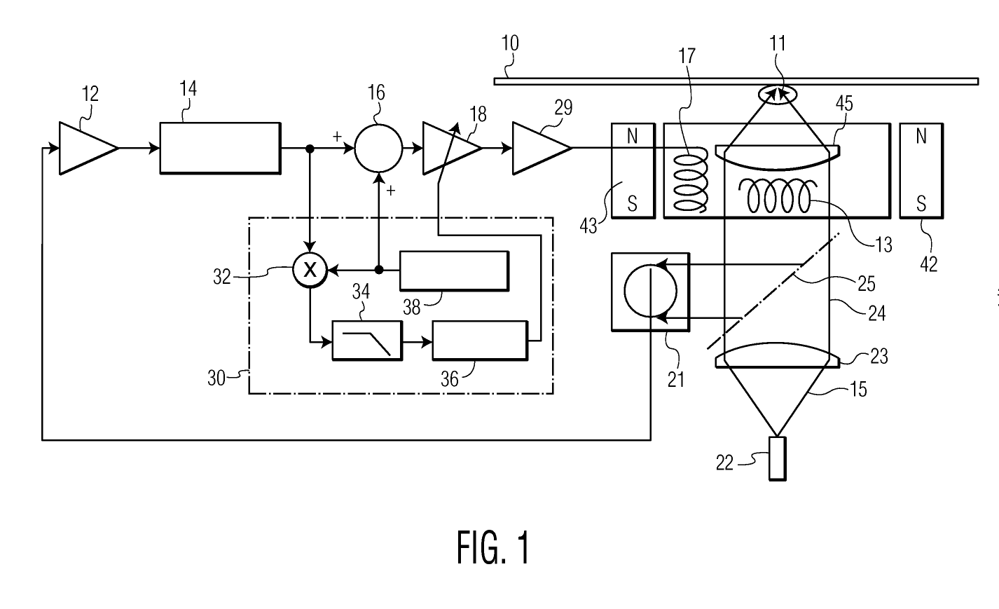

FIG. 1 is a diagram for an optical recording system.

It has been discovered that servo actuators used within optical disc recording devices can have their bandwidth increased by correcting variations that inherently occur. By detecting occurrences requiring gain variations, the gain can be rectified and the necessary gain applied allowing for higher bandwidths. The ability to operate at higher bandwidths enhances focusing and tracking.

FIG. 1 is an illustration of an optical reading/recording system of the invention. In the system of FIG. 1, laser 22 emits beam 15 that passes through collimating lens 23 and forms a column of light 24 that is directed towards focus lens 45. The focus lens 45 forms a light spot on disc 10 in order to read data from and write data to disc 10. The focus lens 45 is mounted in a voice coil motor that moves the lens in both an axial direction and in a radial direction. Focus lens 45 places light spot 11 on optical disc 10 under control of radial actuator coil 13 that controls the movement of focusing lens 45 in a radial direction measured from the center of disc 10 proceeding to the outside edge of disc 10. Focus actuator coil 17 controls the movement of focusing lens 45 in an axial direction orthogonal to the radial direction and parallel to collimated beam 24. Light from collimated beam 24 is reflected off of disc 10 back through focus lens 45 and reflected off of prism 25 to detector 21. Detector 21 is a multiple element detector, preferably having four quadrants. Signals are generated by detector 21 and electronics (not shown) associated with detector 21 to produce tracking and focus error signals in a manner that is well known within the art. These signals are then processed in the manner described below.

The Focus actuator comprises a voice coil 17 that is electromechanically controlled by magnets 42 and 43 and an electrical signal from power driver 29. The signal generated by power driver 29 is determined by gain amplifier 18. The gain amplifier 18 is adjusted by a loop that performs an Automatic Gain Control (AGC) function 30. The AGC function 30 receives a modified signal of light reflected from light spot 11 that has been detected by detector 21. Light from light spot 11 that is detected by detector 21 is processed by pre-amplifier 12 before being sent to Servo Controller 14. The Servo Controller 14 outputs the processed detected light signal to both the AGC function 30 and to adder 16. The AGC function 30 operates as detailed below. An oscillator 38 delivers a sine wave signal that is injected by adder 16 into the servo loop. The sine wave signal causes a disturbance that is fed by the power driver 29 to the actuator. The actuator transfers this into a small movement of the spot 11 with respect to the information layer of the disc 10. The movement is detected by the detector 21 and fed to multiplier 32 by the pre-amplifier 12 and servo controller 14. The phase of the disturbance at the output of the servo controller 14 is compared with the phase of the oscillator by multiplier 32 by means of synchronous detection. The output of the multiplier 32 is filtered by a lowpass filter 34 to remove higher harmonics and integrated by 36. The output of integrator 36 is a DC-voltage that controls the gain stage 18.

This AGC-function 30 adjusts the gain of the complete servo loop to 0 dB for the desired frequency. Conventionally, a gain control function is activated at startup for focusing and radial tracking. According to the invention, the AGC function 30 is activated to make gain corrections that compensate for gain differences at predetermined periods of time, between each read and write cycle and/or upon detection of reflectance changes in excess of a predetermined amount. Preferably, the AGC function 30 is switched on for a short time, on the order of about 100 ms, to adjust the gain to the desired value upon detection of one of the foregoing parameters of predetermined periods of time, changes from read to write or visa versa, and/or upon detection of reflectance changes in excess of a predetermined amount. It will be understood by those skilled in the art from the foregoing discussion that each of these foregoing parameters can be used individually or in combination.

The rotational disc speed is a parameter that should have focus gain optimized. At high speeds (such as 48× for CD, 16× for DVD, 4× for BD), and especially during writing, the signal supplied by the actuator servo controller 14 to gain stage 18 and power driver 29 should have a high loop gain; this need can become critical. A problem that exists within the prior art is attempting to satisfy this need is that in supplying higher gains, oscillations can occur within the loop of the AGC functions 30. The phenomena of loop gain spread can occur due to numerous causes, for example detector sensitivity differences on recorded and non recorded areas. Prior art techniques typically adjust the loop gain to a value that is lower than the maximal value in order to avoid oscillations. The present invention adjusts the AGC gain to a maximum value by means of an AGC mechanism that is activated for short periods of time according to predetermined parameters. For example, during writes, the AGC mechanism is activated for a short time to adjust the gain. The signal derived from oscillator 38 is sufficiently low to avoid high radial or axial excursions that influence the writing quality.

As envisioned by the invention envisions, the AGC function 30 has built in limitations to the gain that are provided to avoid extreme values that could occur as a result of Laser Shot Noise, defective detector zones, optical misalignment; optical skew, thickness variation, disc tilt, disk misalignment, defective discs or disc warping. Each of these potential occurrences illustrates the need for constant optimization of the gain that is applied to focus actuator to insure that data are correctly read from and written to the disc 10.

The diagram in FIG. 1 illustrates that analog circuitry can perform the functions described above. While, each function illustrated in FIG. 1 can be effectively performed using analog electronics, those skilled in the art will readily realize embodiments in which digital electronics are employed for the functions discussed above. For example, embodiments wherein digital signal processing (DSP) devices are employed to process the reflected light received by detector 21 with associated digital electronics to perform, or at least assist in the performance of, the AGC function 30. Therefore, it should be understood that FIG. 1 is a representation of the preferred embodiment of the invention and that the scope of the invention should be measured by the appended claims.

1. A method of automatic gain control for actuators in optical disc drives comprising:
applying a focused beam (11) on to an optical disc (10);
detecting (21) light reflected from the focused beam applied to the optical disc (10);
determining if at least one of a plurality of parameters is satisfied; and
applying automated gain control (30) to a signal derived from detected light reflected from the focused beam if the at least one of the plurality of parameters is satisfied.

2. The method of claim 1 wherein applying automated gain control (30) further comprises implementing a feedback loop to adjust a gain (18) to a desired bandwidth.

3. The method of claim 2 wherein applying automated gain further comprises a gain (18) of the feedback loop determining bandwidth of a servo controller.

4. The method of claim 2 wherein determining further comprises a rotational speed of the optical disc as one of the parameters.

5. The method of claim 2 wherein determining further comprises a reflectivity of the optical disc as one of the parameters.

6. The method of claim 2 wherein determining further comprises a predetermined period of time as one of the parameters.

7. The method of claim 2 wherein determining further comprises reading or writing being performed by the optical disc drive as one of the parameters.

8. The method of claim 1 wherein applying further comprises applying automated gain control for about 100 ms.

9. The method of claim 2 wherein determining further comprises a transition between reading to writing, or writing to reading being performed by the optical disc drive as one of the parameters.

10. The method of claim 1 wherein applying automated gain control provides that the gain has a maximum value for the signal.

11. A system of automatic gain control for actuators in optical disc drives comprising:
a laser (22) having a focused beam (11) on to an optical disc (10);
a detecting element (21) configured to receive a reflected beam (25) from the focused beam (11) on the optical disc (10) and generate a signal from the reflected beam;
processing elements configured to determine if at least one of a plurality of parameters related to recording is satisfied; and
an automated gain control feedback loop (30) that operates on the reflected signal if the at least one of the plurality of parameters is satisfied.

12. The system of claim 11 wherein the automated gain control feedback loop (30) further comprises an adjustment control of the automated gain control feedback loop to adjust gain to a desired bandwidth.

13. The system of claim 12 wherein the automated gain control further comprises a gain (18) of the feedback loop determining bandwidth of a servo controller.

14. The system of claim 12 wherein the at least one the parameters further comprises a rotational speed of the optical disc.

15. The system of claim 12 wherein the at least one the parameters further comprises a current reflectivity state of the optical disc.

16. The system of claim 12 wherein the at least one the parameters further comprises a predetermined period of time as one of the parameters.

17. The system of claim 12 wherein the at least one the parameters further comprises reading or writing being performed by the optical disc drive as one of the parameters.

18. The system of claim 11 wherein the automated gain control is applied for about 100 ms.

19. The system of claim 12 wherein the at least one the parameters further comprises a transition between reading to writing, or writing to reading being performed by the optical disc.

20. The method of claim 11 wherein the automated gain control provides that the gain has a maximum value for the signal.
